(19) United States
(12) Patent Application Publication
(10) Pub. No.: US 2009/0250149 A1
(43) Pub. Date: Oct. 8, 2009

(54) Flexible Non-Pneumatic Tire

(76) Inventor: Marc Sebe, Neyruz (CH)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/085,202

(22) PCT Filed: Nov. 13, 2006
(86) PCT No.: PCT/EP2006/068405

§ 371 Date: May 15, 2008

(30) Foreign Application Priority Data
Nov. 15, 2005 (FR) 05/11559

(51) Int. Cl. B60C 7/24

(52) U.S. Cl. 152/375

(57) ABSTRACT

The tire 1 comprises a plurality of supporting elements 2 interconnected by an interconnection structure 3, the interconnection structure 3 supporting a tread 4, each supporting element being connected by a staple 7 to a rim 6.

The present invention concerns vehicle wheels that use flexible tires that are designed to be capable of carrying a substantial load without any inflation pressure, these tires commonly being known as non-pneumatic tires.

Patent application WO 00/37269 proposes a flexible non-pneumatic tire of this type. It describes a load-bearing structure comprising essentially a plurality of supporting elements arranged substantially radially, in a cyclically symmetric manner all round the circumference of the tire. When the tire described in patent application WO 00/37269 is carrying a load, a certain number of supporting elements present in the contact area undergo considerable bending, which enables them to develop a reaction force that absorbs part of the load. An interconnection structure makes the supporting elements work together, transferring the stresses to the adjacent supporting elements. Thus, the ability of this tire to carry a certain load derives from the bending of the supporting elements present in the contact area of the non-pneumatic elastic tire, and also from the bending of supporting elements outside the contact area of the non-pneumatic elastic tire via the interconnection structure.

Patent application EP 1 359 028 proposes a tire of this type whose interconnection structure is connected to the supporting elements by elastic joints.

The present invention concerns in particular the joint in the zone in the tire where the supporting elements are fixed to a rigid element designed to be attached to the hub of the vehicle during normal use of the tire.

One purpose of the invention is to propose a simple, precise and reliable joint that is compatible with industrial production and assembly of flexible tires.

The invention proposes a flexible tire comprising:
a plurality of supporting elements juxtaposed circumferentially and distributed around a rotation axis of the tire to form a load-bearing structure,
a tread at the radially outer periphery of the load-bearing structure,
the load-bearing structure comprising at least one fixing zone, radially on the side of the rotation axis, to immobilise the said structure on a wheel rim,
the said flexible tire being characterised in that the said rim is annular and each supporting element is fixed on the rim via a staple crimped into essentially axial slots of the rim.

Preferably, the staple consists of a metallic sheet folded so as to fit the profile of the corresponding supporting element in the fixing zone.

Preferably, the arms of the staple extend radially inwards through the slots in the rim, the ends of the said arms forming tabs that are folded against the inner wall of the rim.

Preferably, the staple is seated in slots respectively common to two circumferentially adjacent staples.

Preferably, each staple is seated via at least four tabs in at least four rim slots, and more preferably still, via at least six tabs in at least six rim slots.

Preferably, the supporting elements comprise a stack of flexible strips and layers of a polymeric composition.

Preferably, the supporting elements have a closed ovoid shape.

Preferably, each staple is attached to the corresponding supporting element via the said polymeric composition.

The invention also concerns a wheel disc that can connect the tire rigidly to a hub, the said disc comprising fixing means that can co-operate with the wheel rim.

The invention is described in greater detail with reference to the following figures, in which:

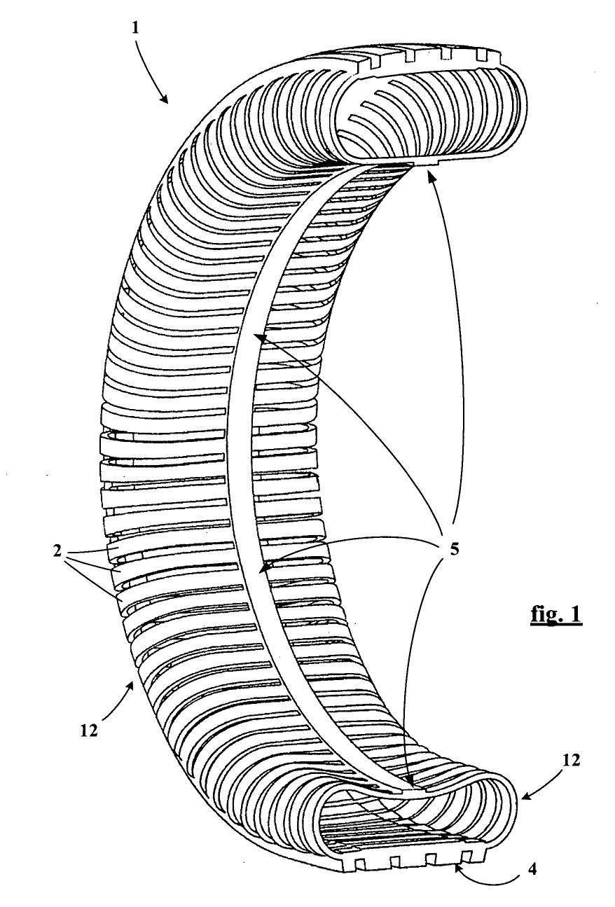

FIG. 1 is a partial perspective view of a non-pneumatic tire;

FIG. 2 is a partial section along B-B of a first embodiment of the invention;

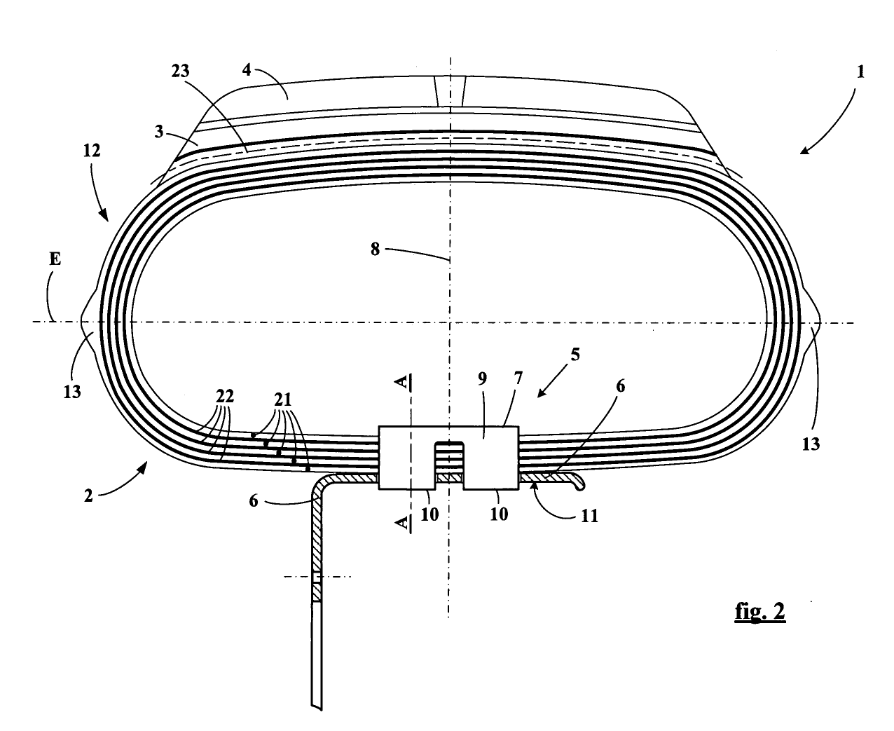

FIG. 3 is a partial section along C-C of a second embodiment of the invention;

FIG. 4 is a detail view of an embodiment of the fixing zone according to the invention;

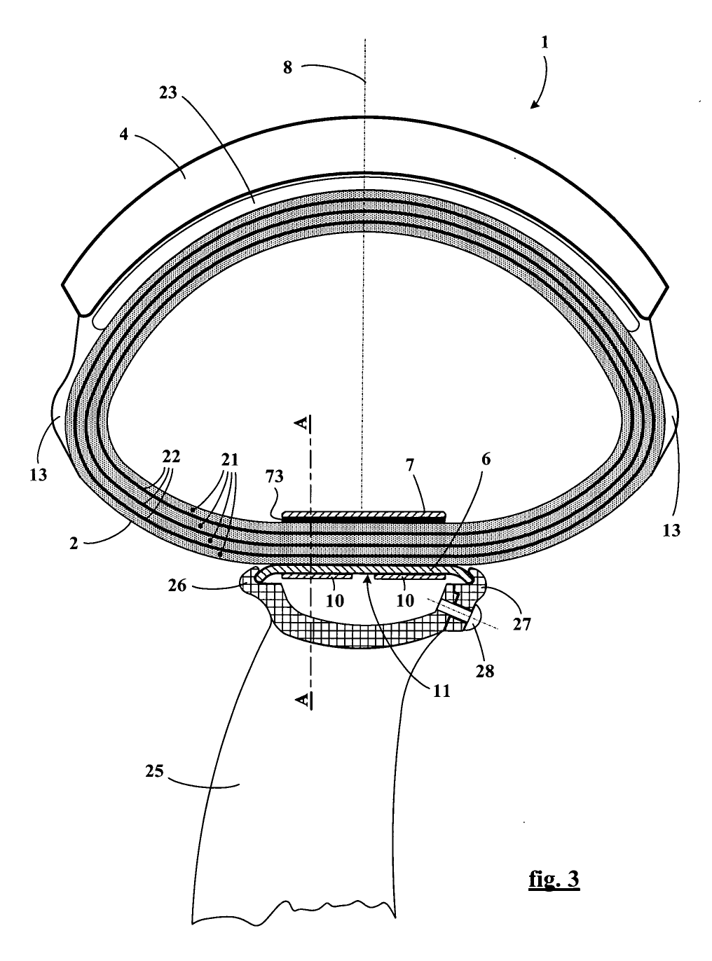

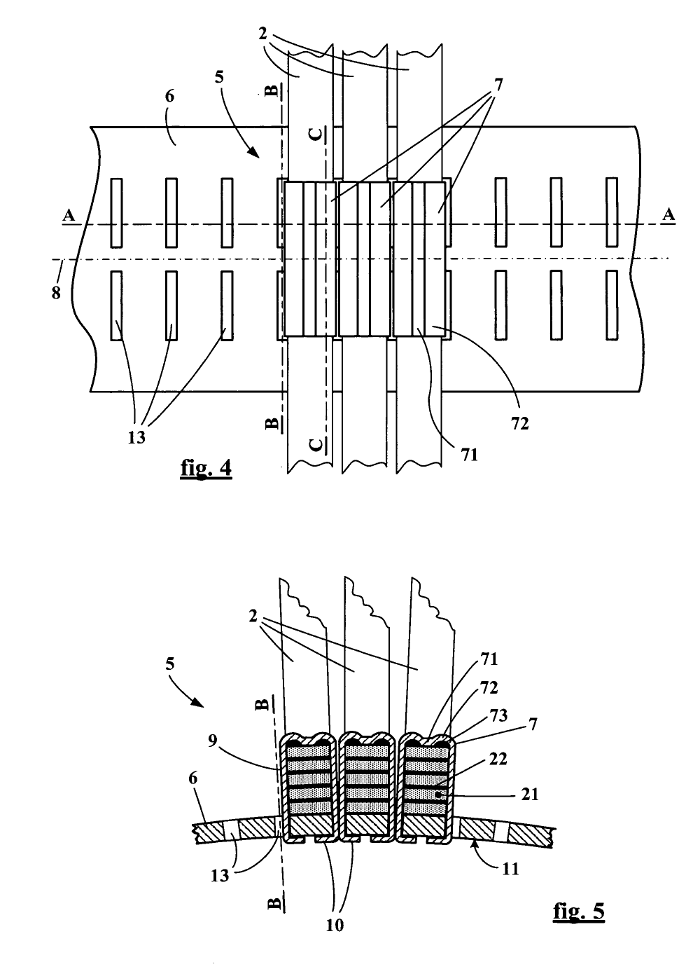

FIG. 5 is a partial section along the plane A-A of FIG. 4;

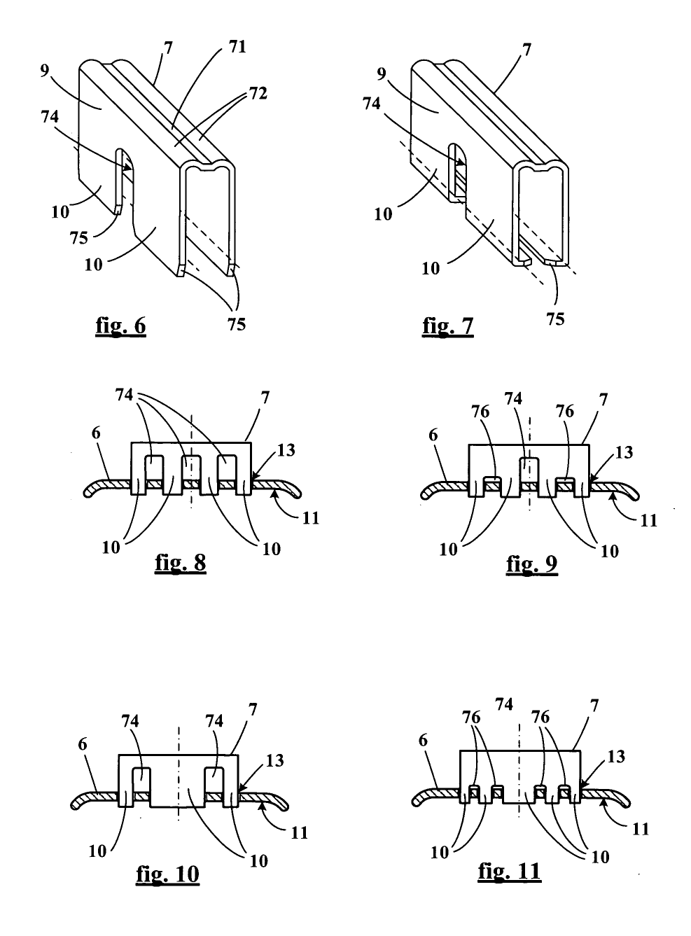

FIGS. 6 and 7 are perspective views of a staple according to the invention, before and after it has been crimped;

FIGS. 8 to 11 show various embodiments of the staple according to the invention;

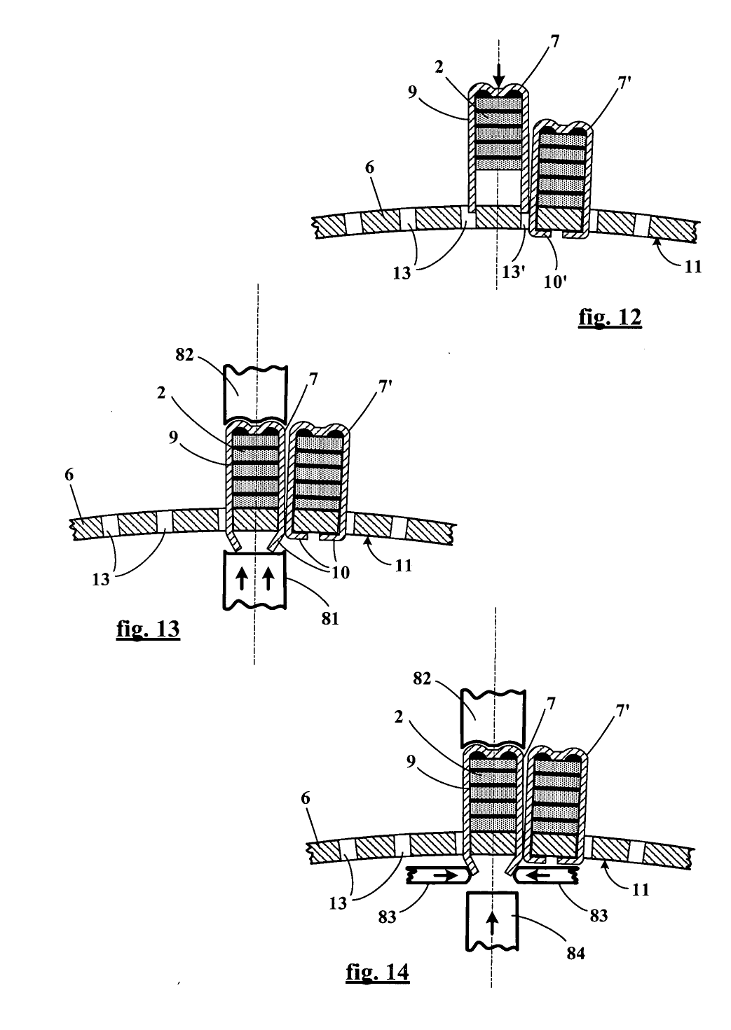

FIGS. 12 to 14 show embodiments of the process of assembling tires according to the invention, viewed in section along A-A;

FIGS. 15 to 18 show two embodiments of a wheel according to the invention, viewed in section along B-B.

In the various figures, essential or similar elements are given the same indexes and their description is not repeated systematically. The figures are shown for illustrative and not limiting purposes.

FIG. 1 shows the general appearance of a flexible tire 1 according to the invention. Such a tire, when associated with any other rigid mechanical element designed to connect the flexible tire and the hub, replaces the assembly consisting of the tire and wheel as known on most of the present road vehicles. The profile of the tire delimits a toroidal internal cavity of ovoid cross-section. The tire 1 comprises a fixing zone 5, two sidewalls 12 and a tread 4. The fixing zone is designed to be rigidly connected to the wheel hub via a mechanical element such as a wheel disc or plate (not shown here). In FIG. 1 the tread 4 has several circumferential ribs, but of course that feature is not in any way limiting. The sidewalls 12 are curved and occupy most of the radial height of the tire 1. The load-bearing structure comprises a plurality of supporting elements 2. The supporting elements are circumferentially adjacent and each extends essentially radially outwards from the fixing zone 5. FIG. 1 also illustrates a principle of this type of non-pneumatic tire according to which it is the bending of the load-bearing elements that enables the load to be carried. In this particular example the tire comprises about a hundred supporting elements 2. Of course that number can vary widely, depending for example on the type of vehicle and the type of use for which the tire is designed, and on the characteristics of the supporting elements. Thus, the number of elements can range for example from 30 to 300.

FIG. 2 shows a first preferred embodiment of the invention. The supporting elements 2 comprise a stack of strips 21 made of a composite material, which are flexible and are radially superposed, with a layer 22 of polymer or a polymeric composition, in particular a diene elastomer or polyurethane, interposed between the strips 21. The joint between the composite material and the said polymer is obtained in a known way, in particular during the operation of curing, polymerisation or final reticulation of the assembly, if necessary with the aid of an adhesive composition adapted to the nature of the polymer, such as that described in the application WO 04/058909.

It may be advantageous to prepare the surface of the strips mechanically (for example by sanding) and/or chemically (for example by using an acidic agent) in order to improve the joint between the strips 21 and the intermediate layers 22.

The bundle of strips bonded to one another in that way forms a slab that can be deformed mainly by bending. Preferably, each flexible strip is closed, i.e. it extends uninterruptedly all round the section of the tire. The stack shown here comprises five strips. However, that feature of the constitution of the laminate is not limiting.

Preferably, an interconnection structure 3 arranged radially under the tread 4 joins the assembly of supporting elements circumferentially. The interconnection structure 3 is relatively rigid in longitudinal tension-compression.

For other details of the constitution of these supporting elements and the interconnection structure it would be useful for the reader to refer to the patent applications WO 00/037269 and EP 1 359 028 mentioned earlier.

Let it simply be remembered that the composite material of the strips 21 comprises reinforcement fibres embedded in a resin. It is preferable to use a matrix of thermosetting resin, but for certain less demanding applications a thermoplastic resin could be suitable. The fibres are preferably arranged mostly longitudinally in each strip. For example, glass fibres could be used. Of course, many other fibres could be used, such as carbon fibres. A hybrid made with fibres of different natures could also be used.

The term “fixing zone” is generally used to denote the part 5 of the tire that is designed to co-operate with a rigid mechanical component which is attached at its other end the hub.

FIG. 2 shows an embodiment of the invention whose profile is particularly suitable for fitting on a 4-wheel passenger car. In this embodiment the supporting elements 2 are closed. The sidewalls 12 of the tire comprise at the level of the equator E protective humps 13 consisting for example of a polymer similar to that of the layer 22 interposed between the flexible strips 21. The tread 4 is connected to the assembly of supporting elements via the interconnection structure 3 and elastic joints 23.

According to the invention, the fixing zone 5 is anchored (i.e. rigidly connected) to an annular rim 6. In this example the fixing zone is axially centred relative to the tire (see the position of the staple relative to the medium plane 8 of the tire). The tire has a large number of such supporting elements, as can be seen clearly in FIG. 1.

Each supporting element 2 rests on the periphery of the rim 6 and is connected to the rim by means of a staple 7. The staple is fixed at the same time radially, axially and circumferentially relative to the rim. Preferably, the fixing is done by crimping (alternatively, fixing could be done by welding). The operation of crimping consists in folding the ends of the tabs 10 of the arms 9 of the staple against the inner wall 11 of the rim. The ends of the arms in fact constitute folding tabs (this aspect, however, can be seen more clearly in FIGS. 5 to 7). The staples 7 (as many of them as there are supporting elements 2) are therefore juxtaposed along the circumference of the rim. Preferably, the number of supporting elements (and thus the number of staples as well) is such that the staples are circumferentially in contact with one another (this preferred feature can best be seen in FIGS. 4 and 5). Alternatively, there may be gaps between the staples, and these gaps may or may not be filled by spacers.

A main function of the wheel rim 6 is to hold the supporting elements fixed relative to one another at the level of their fixing zone. The rim can then be fixed directly or indirectly to the wheel hub (not shown).

FIG. 3 shows another embodiment of a wheel with a flexible tire according to the invention. In this figure the profile of the tire 1 is adapted to its use on a two-wheeled vehicle such as a motorcycle or scooter. The main elements constituting the tire are identical or similar to those of FIG. 2. However, in this case the supporting elements 2 comprise four strips 21 of composite material and three intermediate layers 22. The annular rim 6 is also smaller than that of FIG. 2. This rim is designed to be connected to the wheel hub via a rigid element such as a wheel disc 25 and not directly as is possible with the rim in FIG. 2. The wheel disc 25 (shown only in part) is designed to fix the rotating assembly onto a hub (not shown) of the vehicle. The disc comprises fixing means that can co-operate with the rim. In this preferred example the rim is clamped between a fixed jaw 26 and a removable jaw 27 of the disc 25. The removable jaw 27 can be kept in place by any fixing means, such as rivets or screws 28. The fixed 26 and removable 27 jaws are preferably circular and monoblock, although they can also consist of a plurality of arcs, with or without spaces between the arcs.

In this sectional view the tabs 10 folded against the inside wall 11 of the annular rim can be seen clearly.

FIGS. 4 and 5 show the juxtaposition of the supporting elements 2 on the rim 6. To keep the drawings clear, only part of the annular rim has been shown, with three supporting elements held thereon by their three staples. FIG. 4 shows the fixing zone 5 from the inside of the tire viewed in a radial direction. The axial slots 13 into which the staples are inserted for fixing to the rim can be seen clearly. Each slot preferably receives the arms of two adjacent staples. Here, the section plane B-B corresponding to the view of FIG. 2 and the section plane C-C corresponding to that of FIG. 3 have been indicated.

FIG. 5 shows the same fixing zone in section in a plane (A-A in FIGS. 2 to 4) parallel to the median plane of the tire. In particular, the general radial orientation of the supporting elements and the principle of crimping the staples can be seen. Also clearly visible is the principle according to which the staples are formed so as to embrace the shape of the supporting elements. According to a preferred form, the upper part of the staples comprises a central zone designed to exert pressure at the centre of the stack of flexible strips 21, and rounded bend zones 72 which exert no direct pressure on the stack. The bend zones 72 can receive a filler 73 for example consisting of the same composition as the intermediate layers 22. The staple preferably consists of a stamped-out metal sheet, preferably of steel.

FIG. 6 shows a staple before it has been crimped. FIG. 7 shows the same staple after crimping. This example corresponds to that of the preceding figures. Each arm 9 of the staple has a cut-out 74 which here defines two tabs 10 per arm (i.e. four tabs per staple). Each tab is intended to be folded essentially through 90° during crimping. The cut-out participates in holding the staple on the rim and can also be used for introducing the polymer 22 between the flexible strips 21 (by injection, transfer, casting or some other method known as such). The ends of the tabs can preferably be chamfered as shown here (see the chamfers 75) to facilitate their insertion into the slots of the rim. The length of the slots can therefore be adjusted to the width of the tabs to make the positioning and lateral fixing of the staple more precise without making assembly more difficult.

FIGS. 8 to 11 show various examples of configurations of staples 7, each in its final position crimped onto the rim 6. The corresponding supporting element is not shown.

In FIG. 8 each arm 9 of the staple 7 has four tabs 10 inserted into a corresponding number of slots 13 in the rim 6. The tabs are separated by three cut-outs 74 similar to that in the preceding figures.

The configuration of FIG. 9 is similar to that of FIG. 8 except in that the length of the lateral cut-outs 76 is limited to the minimum necessary for fixing by crimping. The central cut-out 74 is identical to those in the preceding figures.

In FIG. 10 the staple has three tabs 10 per arm and in this case the central tab is wider than the other two. Both cut-outs 74 are long.

In FIG. 11 the staple has five tabs 10 per arm and here the central tab is wider than the other four. All the cut-outs 76 have a length limited to the minimum necessary.

An advantage of increasing the number of tabs is that for a given mechanical stressing of the staple-rim joint, the maximum local stresses are reduced. This applies particularly to the local stresses sustained by the rim because of the spin forces that tend to cause the supporting elements to bend circumferentially relative to the rim.

In contrast, the staple may only have one tab per arm, i.e. it may have no cut-outs, an advantage of this configuration being its great simplicity.

In the examples described here, both arms of a staple are identical or similar since they are preferably intended to co-operate with slots common to the adjacent staple in the tire. However, if the slots are not shared by two staples (for example because the staples are a distance apart), the two arms of the staples can be different, both in the number of their tabs and in the length of their cut-out(s).

FIGS. 12 to 14 illustrate the principle of the process of crimping staples onto an annular rim.

In FIG. 12 the rim 6 already has a supporting element 2′ crimped on by a staple 7′. A new supporting element 2 and its staple 7 are radially moved into its place. The slot 13′ which has already received the tab 10′ of the first staple 7′ now receives the tab 10 (not yet folded) of the second staple 7. Once in position, the staple 7 is in its turn crimped onto the rim 6.

In FIG. 13 the crimping is carried out by a single movement (radially outwards) of a punch 81. A counter-punch 82 can provisionally maintain the staple in place and can even act in the opposite direction to the movement of the punch 81 in order to exert pressure upon the stack of flexible strips.

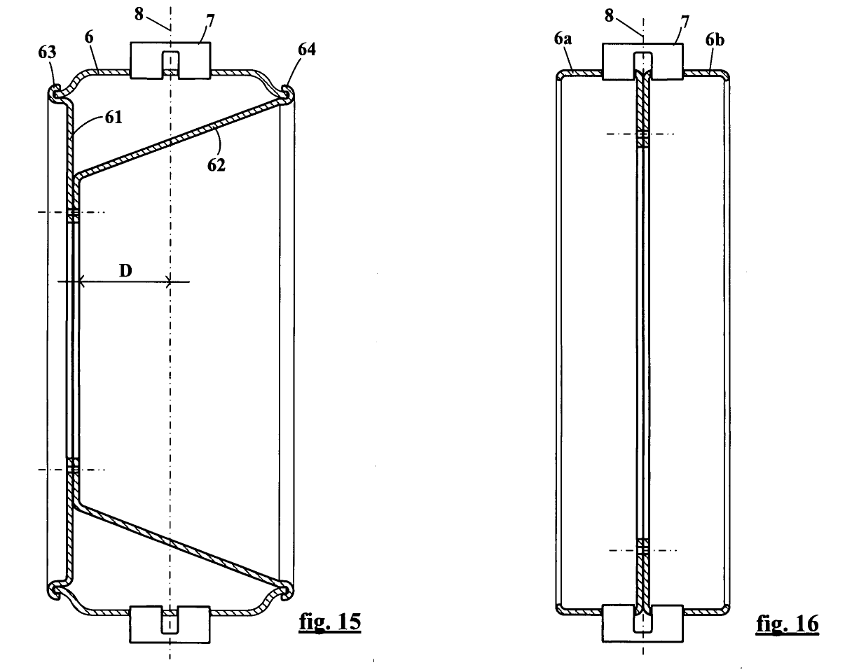

Crimping can also be done in two successive stages as illustrated in FIG. 14. A pincer 83 acting along the circumferential direction of the tire first folds the tabs 10 partially, before a finishing punch 84 completes the radial crimping.

Crimping can be carried out simultaneously on all the tabs of a staple or on only some of them (for example one by one or two by two). Several staples can also be crimped at the same time with the aid of a suitable tool.

To supplement the crimping, fixing can be reinforced still further by welding, for example spot welding the folded tabs against the inside surface 11 of the rim. Alternatively, the staples could be fixed to the rim by welding alone, without prior crimping. Fixing carried out solely by crimping has the particular advantage of not imposing substantial thermal stresses.

The staples can be placed astride the supporting elements at the time when the tire is being assembled, i.e. immediately before they are crimped. The staples can also be positioned during an operation prior to assembly, for example during the moulding of the supporting elements. A preferred method for the fabrication of a supporting element and for assembly with a staple consists in the following stages:
the flexible strips 21 are prepared,
these flexible strips are arranged in a mould in the arrangement desired for the supporting element 2,
a staple 7 is positioned astride the stack of flexible strips in the desired position relative to the supporting element,
a liquid polymer is introduced, which in the solid state can form the intermediate layers 22, attach the staple to the stack, and if necessary form the fillings 73 and the protective humps 13,
the assembly is subjected to a solidification stage.

Solidification can be obtained in a known manner, for example by curing, cooling, reticulation or polymerisation.

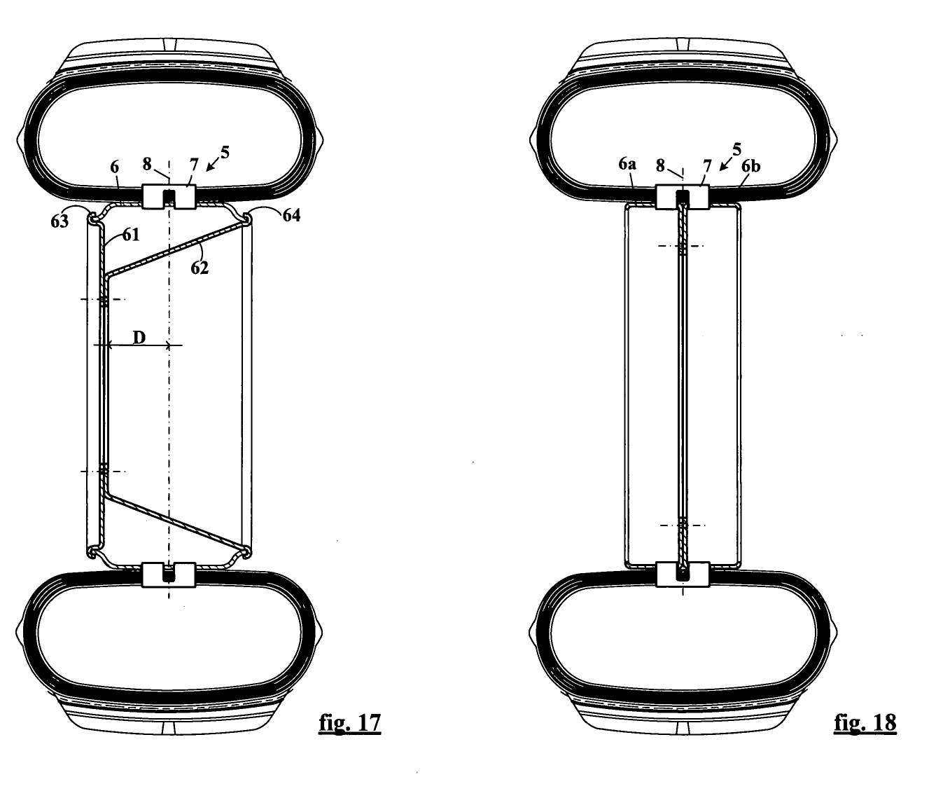

FIGS. 15 and 16 show other examples of how a rigid connection is formed between the annular rim 6 and the wheel hub (not shown).

The example in FIG. 15 uses an outer disc 61 and an inner disc 62 whose peripheries are crimped (and/or welded) onto the flanges of the annular rim 6. The two discs can also be joined directly together, for example by welding.

The example in FIG. 16 uses a rim in two symmetrical parts 6a and 6b. Each staple 7 is in this case crimped into respective slots of the said two parts 6a and 6b. The two parts 6a and 6b can be joined (for example by welding or crimping, not shown).

Thus, the assembly can be bolted on a hub in the same way as a conventional wheel, for example with an offset “D” (see FIG. 15) or with no offset (FIG. 16). A supplementary intermediate element can also be used, such as a wheel disc comparable with that described for FIG. 3.

FIGS. 17 and 18 respectively correspond to FIGS. 15 and 16 and show more completely the whole of the flexible tire wheel of the invention.

In general, the radially outer surface of the rim 6 according to the invention preferably constitutes a bearing surface for the supporting elements. This function is illustrated for example in FIGS. 2 to 5. Reference can be made to the description of patent application WO 00/037269 and in particular FIGS. 7 to 9 thereof as regards the dimensional variation options of these bearing surfaces. The role of the rim's profile and in particular that of its edges in distributing stresses in the supporting elements as a function of the load carried by the tire will also be understood.

Remember that the radially inner portion of the load-bearing structure, i.e. the part closest to the rotation axis of the wheel, makes an important contribution to the bending under load and thus to the comfort provided by the tire. Accordingly, the fixing zone should preferably be located on a fraction corresponding to at most 50% of the axial distance between the lateral limits of the tire. The said radially inner portion of the load-bearing structure thus considerably overhangs beyond the fixing zone. A favourable design arrangement is for the supporting elements, just beyond the fixing zone, to be orientated along a direction essentially parallel to the rotation axis of the tire. That is what is shown in the examples described here. Note, finally, that since the tires described are symmetrical, the fixing zone is essentially central between the axial limits of the tires, although this is not limiting. One could of course adopt an asymmetric structure, particularly for the location of the fixing zone.

According to a variant of the invention, the supporting elements can also be open, i.e. interrupted as shown for example in FIGS. 8 and 9 of patent application WO 00/037269 and in FIG. 1 of patent application EP 1 359 028. In this case closure is effected by the staple and the fixing means described above, and also if necessary by the connection polymer to the staple.

As has been seen, the profile of the annular rim can have various shapes, in particular as a function of its direct or indirect mode of connection to the hub. For example, the rim can be obtained by pressing out of sheet or by drawing. The rim is preferably made of steel. The slots designed to receive the tabs of the staples can in particular be obtained by machining, stamping, or cutting out (laser, water jet).

1. A flexible tire (12) comprising:
a plurality of supporting elements (2) juxtaposed circumferentially and distributed around a rotation axis of the tire to form a load-bearing structure,
a tread (4) at the radially outer periphery of the load-bearing structure,
the load-bearing structure comprising at least one fixing zone (5), radially on the side of the rotation axis, for immobilising said load-bearing structure on a wheel rim (6),
wherein said rim (6) is annular and each supporting element is fixed to the rim via a staple (7) crimped into essentially axial slots (13) of the rim.

2. The flexible tire (1) according to claim 1, in which the staple (7) consists of a metallic sheet folded so as to embrace the profile of the corresponding supporting element (2) in the fixing zone (5).

3. The flexible tire (1) according to claim 2, in which the arms of the staple extend radially inwards through the slots (13) of the rim, the ends of the said arms forming tabs (10) which are folded against the inner wall (11) of the rim.

4. The flexible tire (1) according to claim 3, wherein each staple is crimped into slots (13) respectively common to the two circumferentially adjacent staples.

5. The flexible tire (1) according to claim 3, wherein each staple is crimped by means of at least four tabs (10) in at least four slots (13) of the rim.

6. The flexible tire (1) according to claim 3, wherein each staple is crimped by means of at least six tabs in at least six slots of the rim.

7. The flexible tire (1) according to claim 2, wherein the supporting elements comprise a stack of flexible strips (21) and layers (22) of a polymeric composition.

8. The flexible tire (1) according to claim 7, wherein the supporting elements have a closed ovoid shape.

9. The flexible tire (1) according to claim 8, wherein each staple (7) is fixed to the corresponding supporting element by means of said polymeric composition.

10. A wheel disc (25) that can rigidly connect the tire (1) according to claim 1 to a hub, the disc comprising fixing means (26, 27, 28) capable of co-operating with the rim (6).

11. A flexible tire wheel comprising a flexible tire according to claim 1, wherein each supporting element is fixed to the rim via a staple (7) crimped into essentially axial slots (13) of the rim.

12. The flexible tire (1) according to claim 7, wherein each staple (7) is fixed to the corresponding supporting element by means of said polymeric composition.
